(19) United States
(12) Patent Application Publication
(10) Pub. No.: US 2021/0300321 A1
(43) Pub. Date: Sep. 30, 2021

(54) VEHICLE DRIVE SYSTEM

(71) Applicant: Mazda Motor Corporation, Aki-gun, Hiroshima (JP)

(72) Inventors: Isao TODA, Aki-gun, Hiroshima (JP); Seiyo HIRANO, Aki-gun, Hiroshima (JP); Kei YONEMORI, Aki-gun, Hiroshima (JP)

(73) Assignee: Mazda Motor Corporation, Aki-gun, Hiroshima (JP)

(21) Appl. No.: 17/262,222

(22) PCT Filed: Jul. 24, 2019
(86) PCT No.: PCT/JP2019/028964

§ 371 Date: Jan. 22, 2021

(30) Foreign Application Priority Data
Jul. 31, 2018 (JP) 2018-143352

(51) Int. Cl. B60W 20/00; B60K 7/00; B60K 6/26; B60W 10/06; B60W 10/08

(52) U.S. Cl. CPC B60W 20/00; B60K 7/0007; B60K 6/26; B60W 10/06; B60W 10/08; B60Y 2200/92; B60W 2520/12; B60W 2710/06; B60W 2710/08; B60W 2720/10; B60W 2720/12; B60W 2520/10

(57) ABSTRACT

A vehicle drive system uses an in-wheel motor and has: a vehicle speed sensor; an in-wheel motor that is provided to a wheel of the vehicle and drives the wheel; an internal combustion engine that is provided in a vehicle body of the vehicle and drives the wheel; and control equipment that controls the in-wheel motor and the internal combustion engine. The control equipment causes the internal combustion engine to generate drive power and causes the in-wheel motor not to generate the drive power when the travel speed of the vehicle detected by the vehicle speed sensor is lower than a specified vehicle speed that is higher than zero. The internal combustion engine and the in-wheel motor generate the drive power in the case where the travel speed of the vehicle detected by the vehicle speed sensor is equal to or higher than the specified vehicle speed.

### TECHNICAL FIELD

The present invention relates to a vehicle drive system and, in particular, to a vehicle drive system that uses an in-wheel motor to drive a vehicle.

### BACKGROUND ART

In recent years, vehicle emission control regulations have been tightened in countries across the world, which imposes stringent demands for vehicle fuel economy, carbon dioxide emissions per travel distance, and the like. Some cities restrict entry of vehicles using internal combustion engines for travel into urban areas. In order to satisfy these demands, hybrid-drive vehicles, each of which includes the internal combustion engine and an electric motor, and electric vehicles, each of which is driven by the motor only, have been developed and widely spread.

A drive control system for a vehicle is disclosed in Japanese Patent No. 5,280,961 (Patent Literature 1). In this drive control system, a drive device is provided on a rear wheel side of the vehicle, and two electric motors provided in this drive device drive the rear wheels of the vehicle. Separately from this drive device, the internal combustion engine and the electric motor are connected in series in a drive unit, and the drive unit is provided in a front portion of the vehicle. While power of the drive unit is transmitted to front wheels via a transmission and a primary driveshaft, power of the drive device is transmitted to the rear wheels of the vehicle. In this drive control system, when the vehicle starts moving, the two electric motors in the drive device are driven, and drive power thereof is transmitted to the rear wheels of the vehicle. When the vehicle is accelerated, the drive unit also generates the drive power, which achieves four-wheel drive using the drive unit and the two electric motors in the drive device. As described above, in the drive control system disclosed in Patent Literature 1, the two electric motors, which are provided for the rear wheels of the vehicle, generate the drive power primarily.

An in-wheel motor drive device is disclosed in JP-A-2018-90195 (Patent Literature 2). This in-wheel motor drive device is arranged in a hollow area of the wheel and is configured to drive the wheel. The in-wheel motor drive device includes a motor section and a deceleration section. Rotation of the motor section is transmitted to the rotational wheel, and the rotational wheel is thereby driven.

### CITATION LIST

### Patent Literature

Patent Literature 1: Japanese Patent No. 5,280,961
Patent Literature 2: JP-A-2018-90195

### SUMMARY OF INVENTION

### Technical Problem

Driving of the vehicle using the electric motor does not produce carbon dioxides during travel and thus is advantageous to comply with vehicle emission control regulations, which have been tightened year by year. However, there is a limitation on electricity storable capacity of a battery, which makes it difficult to secure a sufficiently long travel distance. For this reason, a hybrid drive system, in which the internal combustion engine and the electric motor are mounted, has widely been spread as the vehicle drive system. Such a hybrid drive system also reduces carbon dioxide emissions during travel. Thus, like the vehicle disclosed in Patent Literature 1, vehicles using the drive power by the electric motor primarily have been increasing.

As described above, in order to exert sufficient travel performance, a large-capacity battery has to be mounted in the hybrid drive system that uses the drive power of the electric motor primarily. In addition, in order to obtain the sufficient drive power by using the electric motor, the electric motor has to be actuated at a relatively high voltage. For this reason, the large-capacity battery is demanded for the hybrid drive system, which uses the drive power of the electric motor primarily, and an electrical system that supplies the high voltage to the electric motor has to be electrically insulated sufficiently. As a result, these components increase overall vehicle weight and worsen vehicle fuel economy. Furthermore, in order to drive the heavy vehicle by using the electric motor, the larger-capacity battery and the higher voltage are required, which further increases the weight. Thus, a vicious cycle has been a problem.

Meanwhile, in the vehicle drive control system disclosed in Patent Literature 1, the electric motor for driving the rear wheel is directly coupled to the driveshaft for the rear wheels. However, it is considered to arrange this electric motor in the rear wheel to make a so-called in-wheel motor as in the in-wheel motor drive system disclosed in Patent Literature 2. Adoption of the in-wheel motor is advantageous in a point that the driveshaft for coupling the motor and the wheel is no longer necessary and thus the weight can be reduced by weight of the driveshaft. However, even in the case where the in-wheel motor is adopted as the electric motor for starting, accelerating, and cruising the vehicle as in the invention disclosed in Patent Literature 1, the large-sized electric motor is necessary to exert the sufficient travel performance. Thus, the weight increase cannot be avoided. As a result, the full benefit of adopting the in-wheel motor cannot be received.

Therefore, the present invention has an object of providing a vehicle drive system capable of driving a vehicle efficiently by using an in-wheel motor without encountering a vicious cycle of drive enhancement by an electric motor and a vehicle weight increase.

### Solution to Problem

In order to solve the above-described problem, the present invention is a vehicle drive system that uses an in-wheel motor for driving a vehicle and has: a vehicle speed sensor that detects a travel speed of the vehicle; the in-wheel motor that is provided to a wheel of the vehicle and drives the wheel; an internal combustion engine that is provided in a vehicle body of the vehicle and drives the wheel; and control equipment that controls the in-wheel motor and the internal combustion engine. The control equipment is configured to cause the internal combustion engine to generate drive power and cause the in-wheel motor not to generate the drive power when the travel speed of the vehicle detected by the vehicle speed sensor is lower than a specified vehicle speed that is higher than zero. The control equipment is further configured to cause the internal combustion engine and the in-wheel motor to generate the drive power in the case where the travel speed of the vehicle detected by the vehicle speed sensor is equal to or higher than the specified vehicle speed.

In the present invention that is configured as described above, the travel speed of the vehicle is detected by the vehicle speed sensor. The control equipment is provided to the wheel and controls the in-wheel motor and the internal combustion engine for driving the wheel. In addition, when the travel speed of the vehicle detected by the vehicle speed sensor is lower than the specified vehicle speed that is higher than zero, the control equipment causes the internal combustion engine to generate the drive power and causes the in-wheel motor not to generate the drive power. Furthermore, in the case where the travel speed of the vehicle detected by the vehicle speed sensor is equal to or higher than the specified vehicle speed, the control equipment causes the internal combustion engine and the in-wheel motor to generate the drive power.

According to the present invention that is configured as described above, in the case where the travel speed of the vehicle is lower than the specified vehicle speed that is higher than zero, the in-wheel motor does not generate the drive power. Thus, the in-wheel motor is not requested to generate large torque in a low-speed range. As a result, a small-sized electric motor that generates the small torque in the low-speed range can be adopted as the in-wheel motor. Thus, the vehicle can efficiently be driven by using the in-wheel motor.

Meanwhile, in the case where the internal combustion engine is operated in a high-speed range, enrichment control may be executed therein in order to avoid thermal deterioration of an exhaust catalyst system and erosion of exhaust system components (an exhaust temperature sensor, an oxygen concentration sensor, and the like), which are caused by an increase in an exhaust temperature. However, there is a problem that, when air-fuel mixture is made richer than that at the stoichiometric air-fuel ratio by the enrichment control, an amount of toxic substances in exhaust gas is increased. In the present invention that is configured as described above, in the case where the travel speed of the vehicle is equal to or higher than the specified vehicle speed, the control equipment causes the in-wheel motor to generate the drive power. In this way, in the high-speed range where the enrichment control is required in the internal combustion engine, the drive power is supplemented by the in-wheel motor. Thus, the enrichment control can be avoided, or execution of the enrichment control can be suppressed.

In the present invention, preferably, the in-wheel motor is configured to directly drive the wheel, to which the in-wheel motor is provided, without a deceleration mechanism being interposed.

In the present invention, the in-wheel motor generates the drive power in the case where the vehicle speed is equal to or higher than the specified vehicle speed. Thus, the in-wheel motor is not requested for the large torque in the low-speed range. Thus, even without providing the deceleration mechanism, the in-wheel motor can generate a sufficient amount of the torque in a speed range where the torque is requested. In addition, according to the present invention that is configured as described above, the wheel is directly driven without the deceleration mechanism being interposed. Thus, the deceleration mechanism, weight of which is extremely large, can be omitted, and output loss by rotational resistance of the deceleration mechanism can be avoided.

In the present invention, preferably, the in-wheel motor is an induction motor.

In general, the induction motor can be configured to generate large output torque in the high-speed range and to have light weight. Thus, in the present invention, the induction motor is adopted as the in-wheel motor that is not requested for the large torque in the low-speed range. Thus, the electric motor capable of generating the sufficient amount of the torque in a required speed range can be configured to have light weight.

In the present invention, preferably, the control equipment is configured to cause the internal combustion engine to generate the drive power and thereby cause the vehicle to start moving and, when the travel speed of the vehicle detected by the vehicle speed sensor reaches the specified vehicle speed, to cause the in-wheel motor to generate the drive power.

According to the present invention that is configured as described above, the internal combustion engine generates the drive power, and the vehicle starts moving. Thereafter, when the travel speed reaches the specified vehicle speed, the in-wheel motor generates the drive power. Thus, the in-wheel motor is not used at the start of the vehicle. As a result, the electric motor, starting torque of which is extremely small, can be adopted as the in-wheel motor, and the in-wheel motor can have the light weight.

In the present invention, preferably, the in-wheel motor is configured to drive a front wheel of the vehicle, and the internal combustion engine is configured to drive a rear wheel of the vehicle.

In the present invention, preferably, the in-wheel motor is configured to drive a rear wheel of the vehicle, and the internal combustion engine is configured to drive a front wheel of the vehicle.

In the present invention, preferably, the in-wheel motor and the internal combustion engine are configured to drive a front wheel of the vehicle.

In the present invention, preferably, the in-wheel motor and the internal combustion engine are configured to drive a rear wheel of the vehicle.

In addition, the present invention is a vehicle drive system that uses an in-wheel motor for driving a vehicle and has: a vehicle speed sensor that detects a travel speed of the vehicle; the in-wheel motor that is provided to a wheel of the vehicle and drives the wheel; an internal combustion engine that is provided in a vehicle body of the vehicle and drives the wheel; and control equipment that controls the in-wheel motor and the internal combustion engine. The control equipment is configured to cause the internal combustion engine to generate drive power and thereby cause the vehicle to start moving and, when the travel speed of the vehicle detected by the vehicle speed sensor reaches a specified vehicle speed that is higher than zero, to cause the in-wheel motor to generate the drive power.

### Advantageous Effects of Invention

According to the vehicle drive system of the present invention, it is possible to drive the vehicle efficiently by using the in-wheel motor without encountering a vicious cycle of drive enhancement by the electric motor and a vehicle weight increase.

### BRIEF DESCRIPTION OF DRAWINGS

FIG. 1 is a layout view of a vehicle on which a hybrid drive system according to a first embodiment of the present invention is mounted.

FIG. 2 is a perspective view in which a front portion of the vehicle, on which the hybrid drive system according to the first embodiment of the present invention, is seen from above.

FIG. 3 is a perspective view in which the front portion of the vehicle, on which the hybrid drive system according to the first embodiment of the present invention is mounted, is seen from a side.

FIG. 4 is a cross-sectional view that is taken along line iv-iv in FIG. 2.

FIG. 5 is a block diagram illustrating input/output of various signals in the hybrid drive system according to the first embodiment of the present invention.

FIG. 6 is a block diagram illustrating a power supply configuration of the hybrid drive system according to the first embodiment of the present invention.

FIG. 7 is a graph schematically illustrating an example of a change in a voltage in the case where electricity is regenerated into a capacitor in the hybrid drive system according to the first embodiment of the present invention.

FIG. 8 is a graph illustrating a relationship between output of each motor used in the hybrid drive system according to the first embodiment of the present invention and a vehicle speed.

FIG. 9 is a graph schematically illustrating an air-fuel ratio with respect to requested output and an engine speed.

FIG. 10 is a cross-sectional view schematically illustrating a structure of an in-wheel motor that is adopted for the hybrid drive system according to the first embodiment of the present invention.

FIG. 11 is a flowchart of control by the controller in the hybrid drive system according to the first embodiment of the present invention.

FIG. 12 is a time chart illustrating an example of operation of the hybrid drive system according to the first embodiment of the present invention.

FIG. 13 is a table schematically illustrating changes in acceleration applied to the vehicle in the case where a transmission in the hybrid drive system according to the first embodiment of the present invention is shifted down or shifted up.

FIG. 14 is a flowchart of control by a controller in a hybrid drive system according to a second embodiment of the present invention.

FIG. 15 is a time chart illustrating an example of operation of the hybrid drive system according to the second embodiment of the present invention.

FIG. 16 is a layout view of a vehicle on which a hybrid drive system according to a first modified embodiment of the present invention is mounted.

FIG. 17 is a layout view of a vehicle on which a hybrid drive system according to a second modified embodiment of the present invention is mounted.

FIG. 18 is a layout view of a vehicle on which a hybrid drive system according to a third modified embodiment of the present invention is mounted.

### DESCRIPTION OF EMBODIMENTS

A preferred embodiment of the present invention will be described with reference to the accompanying drawings.

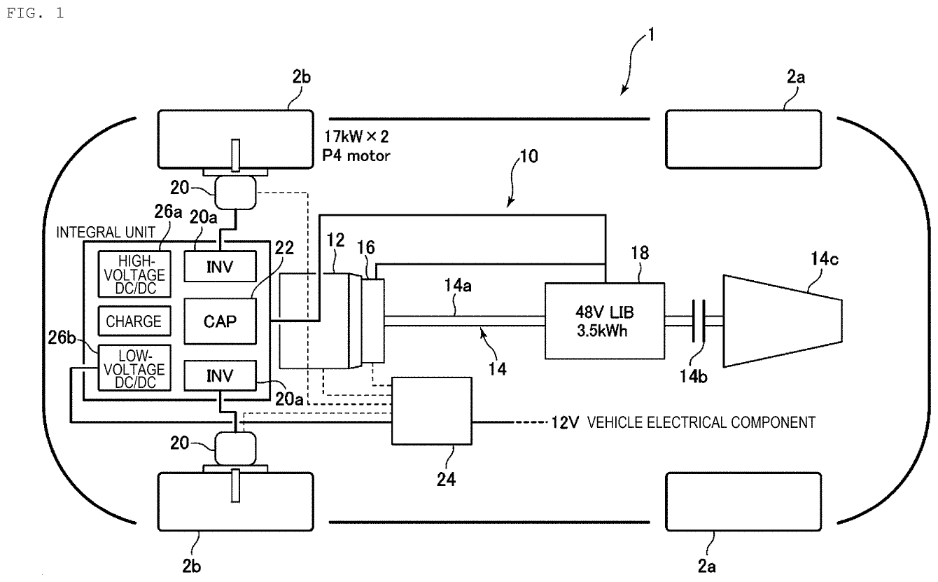

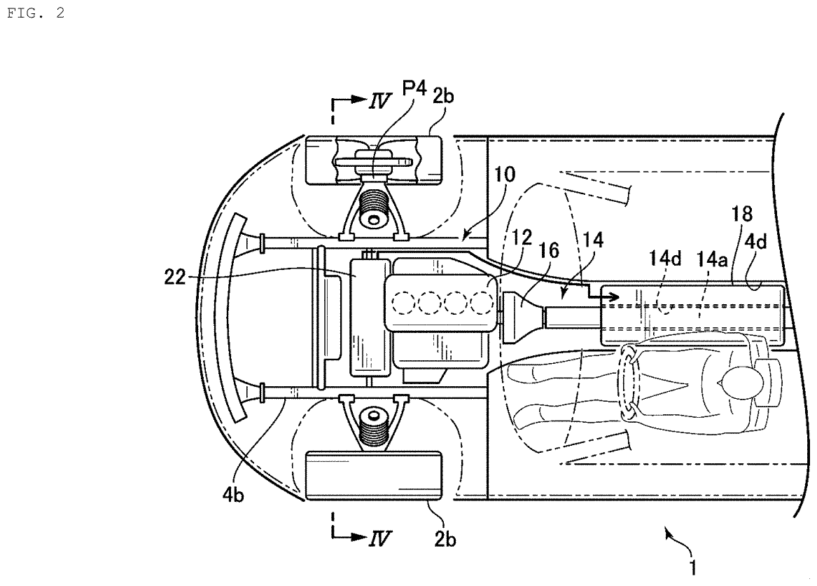

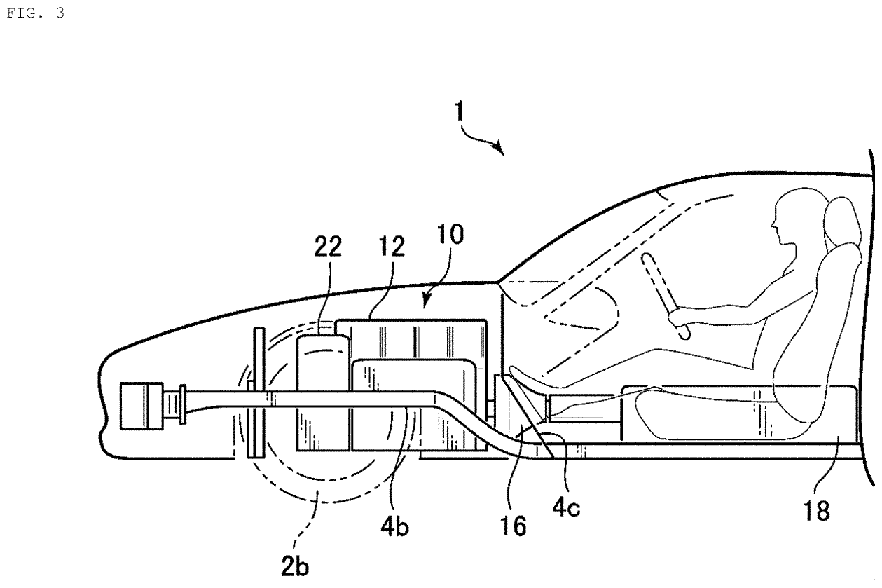

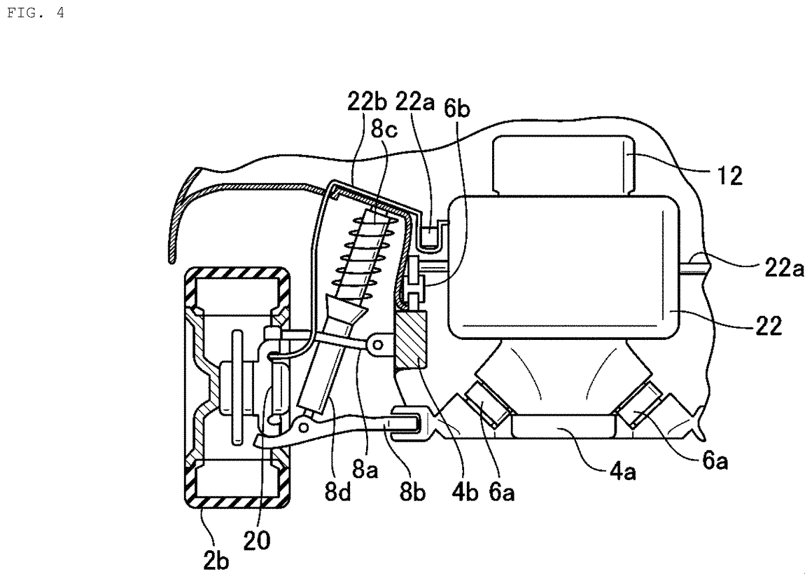

FIG. 1 is a layout view of a vehicle on which a hybrid drive system according to a first embodiment of the present invention is mounted. FIG. 2 is a perspective view in which a front portion of the vehicle, on which the hybrid drive system in this embodiment is mounted, is seen from above, and FIG. 3 is a perspective view in which the front portion of the vehicle is seen from a side. FIG. 4 is a cross-sectional view that is taken along line iv-iv in FIG. 2.

As illustrated in FIG. 1, a vehicle 1, on which the hybrid drive system as a vehicle drive system according to the first embodiment of the present invention is mounted, is a so-called front-engine, rear-wheel-drive (FR) vehicle on which an engine 12 as an internal combustion engine is mounted in a front portion in front of a driver's seat and which drives a right and left pair of rear wheels 2a as primary drive wheels. A right and left pair of front wheels 2b as secondary drive wheels is driven by in-wheel motors.

A hybrid drive system 10 according to the first embodiment of the present invention, which is mounted on the vehicle 1, has: the engine 12 that drives the rear wheels 2a; a power transmission mechanism 14 that transmits drive power to the rear wheels; a battery 18 as a power storage device; in-wheel motors 20, each of which drives respective one of the front wheels 2b; a capacitor 22; and a controller 24 as control equipment.

The engine 12 is the internal combustion engine that generates the drive power for the rear wheels 2a as the primary drive wheels of the vehicle 1. As illustrated in FIG. 2 to FIG. 4, in this embodiment, an in-line four-cylinder engine is adopted as the engine 12, and the engine 12, which is arranged in the front portion of the vehicle 1, drives the rear wheels 2a via the power transmission mechanism 14. The engine 12 is provided with an alternator 16, and the alternator 16 is configured to generate electricity in association with rotation of an output shaft of the engine 12. The electricity that is generated by the alternator 16 is stored in the battery 18.

As illustrated in FIG. 4, in this embodiment, the engine 12 is a flywheel-less engine that does not include a flywheel, and is mounted to a subframe 4a of the vehicle 1 via an engine mount 6a. Furthermore, the subframe 4a is fastened to a lower portion of a front side frame 4b and a lower portion of a dashboard 4c at a rear end thereof.

The power transmission mechanism 14 is configured to transmit the drive power, which is generated by the engine 12, to the rear wheels 2a as the primary drive wheels. As illustrated in FIG. 1 to FIG. 3, the power transmission mechanism 14 includes a propeller shaft 14a that is connected to the engine 12, a clutch 14b, and a transmission 14c as a stepped transmission. In a propeller shaft tunnel 4d (FIG. 2), the propeller shaft 14a extends from the engine 12, which is arranged in the front portion of the vehicle 1, toward a rear portion of the vehicle 1. A rear end of the propeller shaft 14a is connected to the transmission 14c via the clutch 14b. An output shaft of the transmission 14c is connected to an axle (not illustrated) of the rear wheels 2a and drives the rear wheels 2a.

In this embodiment, a so-called transaxle layout is adopted for the transmission 14c. As a result, a transmission body that has a large outer diameter is not present at a position right behind the engine 12, which allows reduction in a width of a floor tunnel (the propeller shaft tunnel 4d). Thus, an occupant foot space on a center side is sufficiently secured, and an occupant can assume a laterally-symmetrical lower body posture that faces straight to the front.

The battery 18 is the power storage device that primarily stores the electricity used to actuate the in-wheel motors 20. As illustrated in FIG. 2, in this embodiment, the battery 18 is arranged in the propeller shaft tunnel 4d in a manner to surround a torque tube 14d that covers the propeller shaft 14a. In this embodiment, a lithium-ion battery (LIB) of 48 V, 3.5 kWh is used as the battery 18.

As described above, since the transaxle layout is adopted in this embodiment, toward a space in front of the thus-provided floor tunnel (the propeller shaft tunnel 4d), a volume for accommodating the battery 18 can be increased. In this way, capacity of the battery 18 can be secured and increased without increasing the width of the floor tunnel and thereby narrowing the occupant space on the center side.

As illustrated in FIG. 4, in order to generate the drive power for the front wheel 2b as the secondary drive wheel, the in-wheel motor 20 is provided to each of the front wheels 2b and is provided in an unsprung portion of the vehicle 1. In this embodiment, each of the front wheels 2b is supported by a double wishbone suspension and is suspended by an upper arm 8a, a lower arm 8b, a spring 8c, and a shock absorber 8d. The in-wheel motor 20 is an in-wheel motor and is accommodated in a wheel rim of each of the front wheels 2b. Thus, the in-wheel motor 20 is provided in the so-called “unsprung portion” of the vehicle 1 and is configured to drive respective one of the front wheels 2b. In addition, as illustrated in FIG. 1, a current from the capacitor (CAP) 22 is converted into an alternating current by each inverter 20a and is then supplied to respective one of the in-wheel motors 20. Furthermore, in this embodiment, the in-wheel motor 20 is not provided with a reducer as a deceleration mechanism. The drive power of the in-wheel motor 20 is directly transmitted to the front wheel 2b, and thus the wheel is directly driven. Moreover, in this embodiment, an induction motor of 17 kW is adopted as each of the in-wheel motors 20.

The capacitor (CAP) 22 is provided to accumulate the electricity that is regenerated by the in-wheel motors 20. As illustrated in FIG. 2 and FIG. 3, the capacitor 22 is arranged right in front of the engine 12 and supplies the electricity to the in-wheel motor 20 that is provided to each of the front wheels 2b of the vehicle 1. As illustrated in FIG. 4, in the capacitor 22, a bracket 22a that protrudes from a lateral surface thereof on each side is supported by the front side frame 4b via a capacitor mount 6b. A harness 22b that extends from the in-wheel motor 20 to the capacitor 22 enters an engine component through an upper end of a side portion of a wheel house wall surface. Furthermore, the capacitor 22 is configured to accumulate electric charges at a higher voltage than the battery 18, and is arranged in an area between the right and left front wheels 2b as the secondary drive wheels.

The controller 24 is configured to control the engine and the in-wheel motors 20. More specifically, the controller 24 can be constructed of a microprocessor, a memory, an interface circuit, programs for actuating these components (none of them are illustrated), and the like. A detailed description on control by the controller 24 will be made below.

As illustrated in FIG. 1, a high-voltage DC/DC converter 26a and a low-voltage DC/DC converter 26b as voltage converters are arranged near the capacitor 22. These high-voltage DC/DC converter 26a and low-voltage DC/DC converter 26b, the capacitor 22, and the two inverters 20a are unitized to constitute an integral unit.

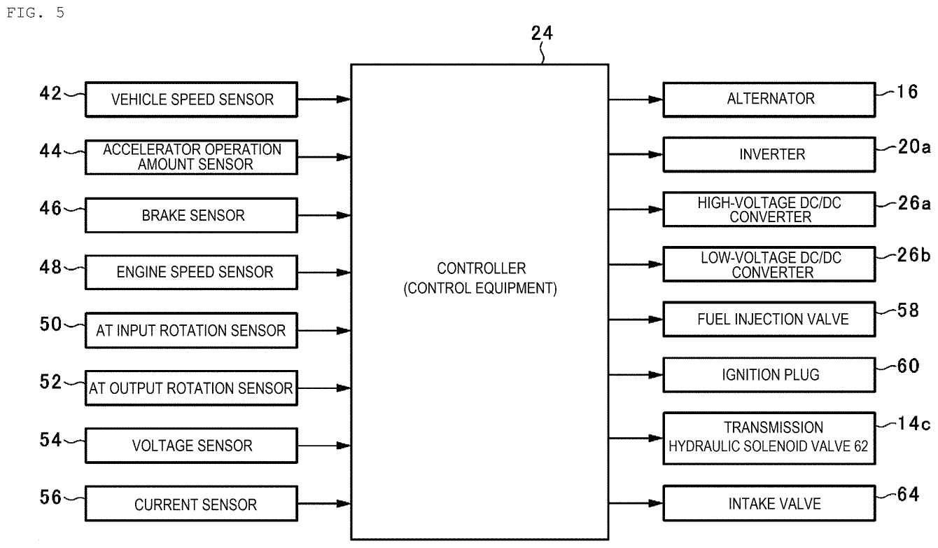

Next, a description will be made on an overall configuration and a power supply configuration of the hybrid drive system 10 as well as driving of the vehicle 1 by each of the motors according to the first embodiment of the present invention with reference to FIG. 5 to FIG. 8.

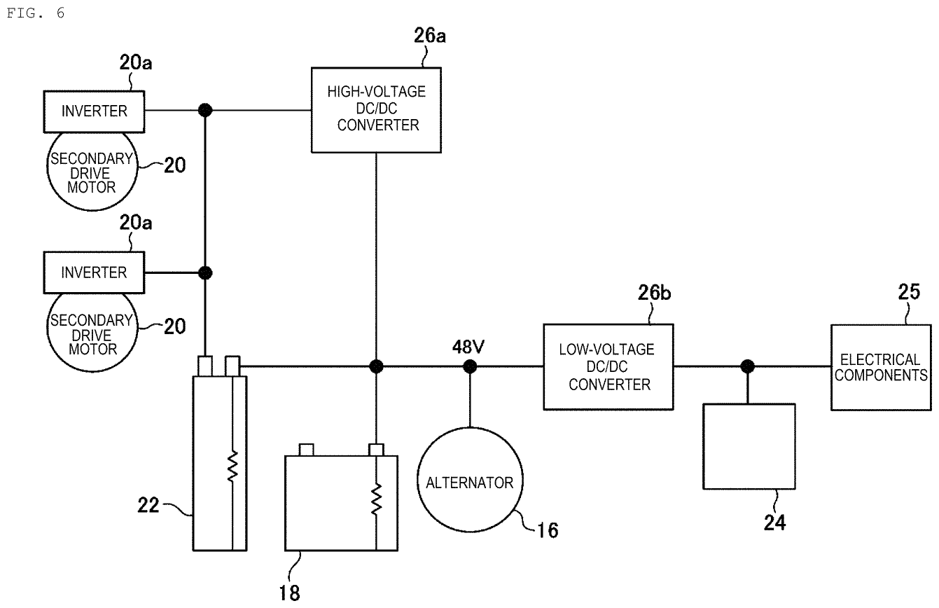

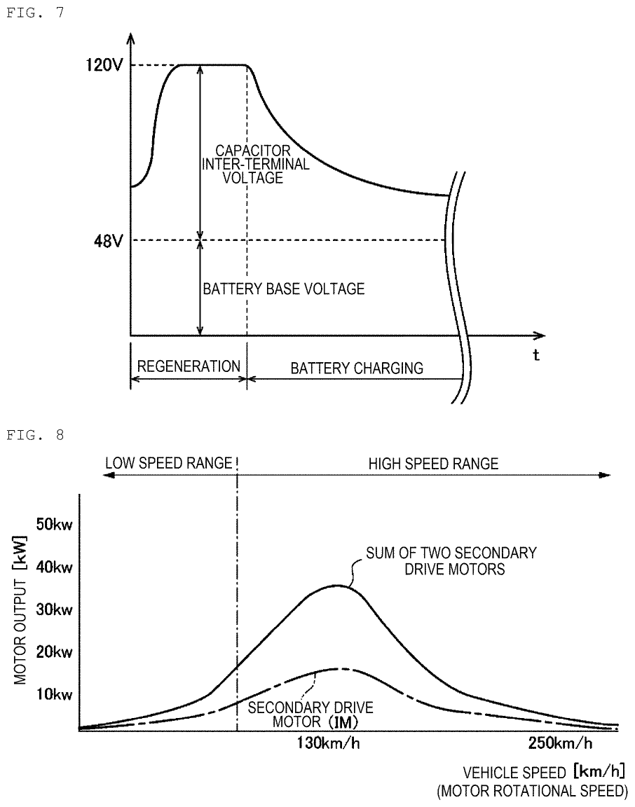

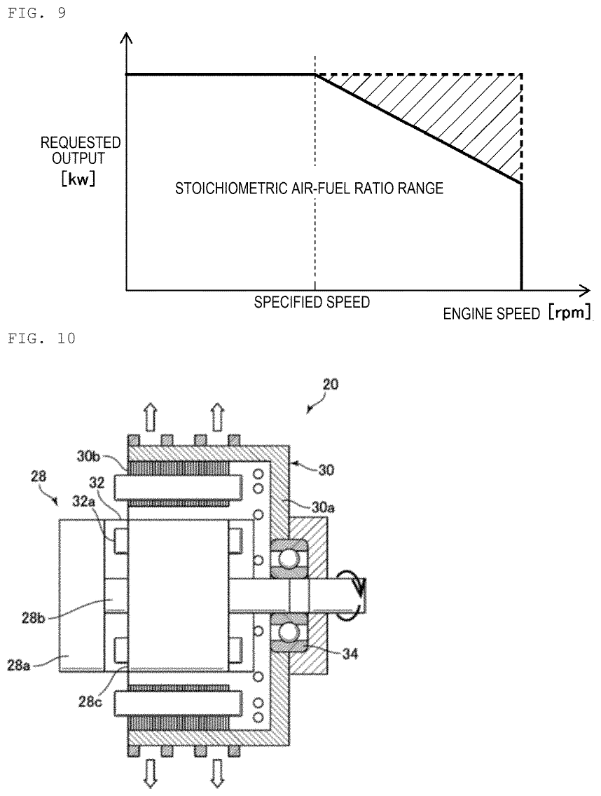

FIG. 5 is a block diagram illustrating input/output of various signals in the hybrid drive system 10 according to the first embodiment of the present invention. FIG. 6 is a block diagram illustrating the power supply configuration of the hybrid drive system 10 according to the first embodiment of the present invention. FIG. 7 is a graph schematically illustrating an example of a change in the voltage in the case where the electricity is regenerated into the capacitor 22 in the hybrid drive system 10 of this embodiment. FIG. 8 is a graph illustrating a relationship between output of the motors used in the hybrid drive system 10 of this embodiment and a vehicle speed.

First, a description will be made on the input/output of the various signals in the hybrid drive system 10 according to the first embodiment of the present invention. As illustrated in FIG. 5, the controller 24 receives detection signals from a vehicle speed sensor 42, an accelerator operation amount sensor 44, a brake sensor 46, an engine speed sensor 48, an automatic transmission (AT) input rotation sensor 50, an automatic transmission (AT) output rotation sensor 52, a voltage sensor 54, and a current sensor 56. In addition, the controller 24 is configured to send control signals to the alternator 16 provided to the engine 12, the inverters 20a for the in-wheel motors 20, the high-voltage DC/DC converter 26a, the low-voltage DC/DC converter 26b, a fuel injection valve 58, an ignition plug 60, a hydraulic solenoid valve 62 for the transmission 14c, and an intake valve 64 to control these components.

Next, a description will be made on the power supply configuration of the hybrid drive system 10 according to the first embodiment of the present invention. As illustrated in FIG. 6, the battery 18 and the capacitor 22, which are provided in the hybrid drive system 10, are connected in series. A reference output voltage of the battery 18 is set to approximately 48 V, and the in-wheel motor 20 is driven at the maximum voltage of 120 V that is higher than 48 V as a sum of the output voltage of the battery 18 and an inter-terminal voltage of the capacitor 22. Thus, the in-wheel motor 20 is always driven with the electricity that is supplied via the capacitor 22.

The inverter 20a is mounted to each of the in-wheel motors 20 and converts the output of the battery 18 and the capacitor 22 into the alternating current so as to drive each of the in-wheel motors 20 as the induction motor. Since the in-wheel motor 20a is driven at the higher voltage than 48 V as the reference voltage of the battery 18, a superior insulation property is demanded for the harness (electrical wire) 22b through which the electricity is supplied to the in-wheel motor 20a. However, since the capacitor 22 is arranged near each of the in-wheel motors 20, it is possible to minimize weight increase that is caused by improvement in the insulation property of the harness 22b.

During deceleration of the vehicle 1, or the like, each of the in-wheel motors 20 functions as a generator and regenerates kinetic energy of the vehicle 1 to generate the electricity. During deceleration of the vehicle 1, or the like, the alternator 16 also regenerates the kinetic energy of the vehicle 1 to generate the electricity. The electricity that is regenerated by the alternator 16 is accumulated in the battery 18 while the electricity that is regenerated by each of the in-wheel motors 20 is mainly accumulated in the capacitor 22.

The high-voltage DC/DC converter 26a as the voltage converter is connected between the battery 18 and the capacitor 22. When the electric charges accumulated in the capacitor 22 (when the inter-terminal voltage of the capacitor 22 is reduced), this high-voltage DC/DC converter 26a boosts the voltage of the battery 18 to charge the capacitor 22. On the contrary, in the case where the inter-terminal voltage of the capacitor 22 is increased to be equal to or higher than a specified voltage due to regeneration of energy by each of the in-wheel motors 20, the high-voltage DC/DC converter 26a reduces the electric charges accumulated in the capacitor 22 and applies the electric charges to the battery 18 to charge the battery 18. That is, the electricity that is regenerated by the in-wheel motors 20 is accumulated in the capacitor 22, and the accumulated electric charges are then partially stored in the battery 18 via the high-voltage DC/DC converter 26a.

Furthermore, the low-voltage DC/DC converter 26b is connected between the battery 18 and 12-V electrical components 25. The controller 24 in the hybrid drive system 10 and many of the electrical components 25 of the vehicle 1 are actuated with the voltage of 12 V. Thus, the electric charges that are accumulated in the battery 18 are reduced to 12 V by the low-voltage DC/DC converter 26b and are then supplied to these devices.

Next, a description will be made on charging and discharging of the capacitor 22 with reference to FIG. 7.

As illustrated in FIG. 7, the voltage of the capacitor 22 is a sum of a base voltage by the battery 18 and the inter-terminal voltage of the capacitor 22 itself. During the deceleration of the vehicle, or the like, the electricity is regenerated by each of the in-wheel motors 20, and the regenerated electricity is stored in the capacitor 22. When the capacitor 22 is charged, the inter-terminal voltage thereof is increased in a relatively rapid manner. When the voltage of the capacitor 22 is increased to be equal to or higher than the specified voltage by charging, the high-voltage DC/DC converter 26a reduces the voltage of the capacitor 22 to charge the battery 18. As illustrated in FIG. 7, this charging of the battery 18 from the capacitor 22 is conducted relatively gentler than changing of the capacitor 22, and the voltage of the capacitor 22 is reduced to the appropriate voltage in a relatively gentle manner.

That is, the electricity that is regenerated by each of the in-wheel motors 20 is temporarily accumulated in the capacitor 22 and is then gently stored in the battery 18. Depending on a period in which the regeneration occurs, the regeneration of the electricity by each of the in-wheel motors 20 and charging of the battery 18 from the capacitor 22 possibly overlap.

Meanwhile, the electricity that is regenerated by the alternator 16 is directly stored in the battery 18.

Next, a description will be made on a relationship between the vehicle speed and output of the in-wheel motor(s) 20 in the hybrid drive system 10 according to the first embodiment of the present invention with reference to FIG. 8. FIG. 8 is a graph illustrating a relationship between a speed of the vehicle 1 and the output of the in-wheel motor(s) 20 at each of the speeds in the hybrid drive system 10 of this embodiment. In FIG. 8, the output of the single in-wheel motor 20 is indicated by a one-dot chain line, and a sum of the output of the two in-wheel motors 20 is indicated by a solid line. In FIG. 8, a horizontal axis represents the speed of the vehicle 1, and a vertical axis represents the output of the in-wheel motor(s) 20. However, due to a constant relationship between the speed of the vehicle 1 and a rotational speed of each of the motors, even in the case where the motor rotational speed is set on the horizontal axis, the output of the in-wheel motor(s) 20 exhibits a similar curve to that in FIG. 8.

Here, since the induction motor is adopted for each of the in-wheel motors 20, as indicated by the one-dot chain line and the solid line in FIG. 8, the output of the in-wheel motor(s) 20 is extremely low in a low vehicle speed range. The output thereof is increased with an increase in the vehicle speed. The maximum output is obtained at the vehicle speed of approximately 130 km/h. Then, the motor output is reduced. In this embodiment, each of the in-wheel motors 20 is configured to be driven at approximately 120 V and, at the vehicle speed of approximately 130 km/h, generate the output of approximately 17 kW per motor and approximately 34 kW by a total of the two motors. That is, in this embodiment, the in-wheel motor(s) 20 has a torque curve that peaks at approximately 600 to 800 rpm, and generates the maximum torque of approximately 200 Nm.

The solid line in FIG. 8 represents an output value of the in-wheel motor(s) 20 even in the low vehicle speed range. However, as will be described below, in reality, none of the in-wheel motors 20 is driven in the low vehicle speed range. More specifically, the vehicle is driven only by the engine 12 at a vehicle start and in the low vehicle speed range. The two in-wheel motors 20 generate the output only when the large output is necessary in a high vehicle speed range (when the vehicle 1 is accelerated in the high vehicle speed range, or the like). Just as described, the induction motors (the in-wheel motors 20) capable of generating the large output in a high rotational speed range are only used in the high-speed range. Thus, while a vehicle weight increase is suppressed to be small, the sufficient output can be obtained when necessary (during acceleration at a specified speed or higher, or the like).

Next, a description will be made on control of the engine 12 in the hybrid drive system 10 according to the first embodiment of the present invention with reference to FIG. 9. FIG. 9 is a graph schematically illustrating an air-fuel ratio with respect to requested output and an engine speed.

The controller 24, which is provided in the hybrid drive system 10, determines the requested output for the engine 12 primarily on the basis of the detection signals of the accelerator operation amount sensor 44 and the vehicle speed sensor 42, and controls the fuel injection valve 58, the ignition plug 60, the intake valve 64, and the like to obtain this requested output. The controller 24 further controls a fuel injection amount from the fuel injection valve 58 and an intake air amount by the intake valve 64 such that air-fuel mixture is burned at the substantially stoichiometric air-fuel ratio (for example, in regard to gasoline fuel, air amount/fuel amount=approximately 14.7) in the engine 12 at the same time as obtainment of the requested output. Since the controller 24 causes the fuel to be burned at the stoichiometric air-fuel ratio in the engine 12, just as described, the controller 24 improves energy efficiency and suppresses production of toxic substances.

However, in the case where the fuel is burned at the stoichiometric air-fuel ratio in a state where the requested output for the engine 12 is high and the engine speed is high, an exhaust temperature from the engine 12 is excessively increased. As a result, temperatures of components in an engine exhaust system, such as an exhaust temperature sensor and an oxygen concentration sensor (which are not illustrated), each exceed a temperature at which reliability of the component can be secured, and such components are possibly damaged. In order to avoid this problem, in the conventional engine control, enrichment control is executed in an engine high-output/high-speed range so as to suppress an increase in the exhaust temperature.

More specifically, like a shaded portion in FIG. 9, in a range where the requested output for driving of the vehicle is high and the engine speed is high, the enrichment control is executed to reduce the exhaust temperature by burning the air-fuel mixture, concentration of fuel of which is higher than that at the stoichiometric air-fuel ratio. Meanwhile, in the hybrid drive system 10 of this embodiment, as will be described below, in a range where the engine speed is high (the vehicle speed is high), the in-wheel motors 20 are driven to generate the output. In this way, requested torque is partially covered by the in-wheel motors 20. Thus, even in the range of the shaded portion in FIG. 9, the engine 12 can be operated at the stoichiometric air-fuel ratio. That is, as in the range of the shaded portion in FIG. 9, in the state where the engine speed is high and the requested output for driving the vehicle 1 is high, the in-wheel motors 20 are driven, and the required output is supplemented by the in-wheel motors 20. As a result, an amount of the output that should be generated by the engine 12 is reduced. Thus, even in the range where the requested output is high and the engine speed is high, the engine 12 can be operated at the stoichiometric air-fuel ratio.

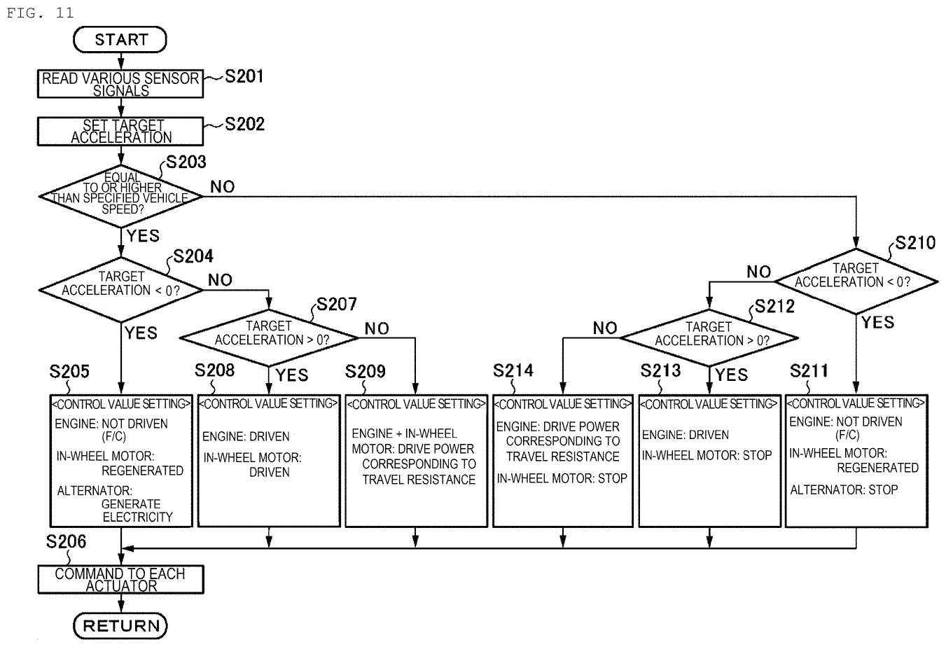

Next, a description will be made on a configuration of the in-wheel motor 20 that is adopted for the hybrid drive system 10 according to the first embodiment of the present invention with reference to FIG. 10. FIG. 10 is a cross-sectional view schematically illustrating a structure of the in-wheel motor 20.

As illustrated in FIG. 10, the in-wheel motor 20 is the induction motor of an outer rotor type configured to include a stator 28 and a rotor 30 that rotates about this stator.

The stator 28 has: a substantially disc-shaped stator base 28a; a stator shaft 28b that extends from a center of this stator base 28a; and a stator coil 28c that is attached around this stator shaft 28b. The stator coil 28c is accommodated in an electrical insulating fluid chamber 32, is immersed in an electrical insulating fluid 32a that is filled therein, and is subjected to ebullient cooling.

The rotor 30 is formed in a substantially cylindrical shape in a manner to surround the stator 28, and has: a rotor body 30a that is formed in the substantially cylindrical shape with one closed end; and a rotor coil 30b that is arranged on an inner circumferential wall surface of the rotor body 30a. The rotor coil 30b is arranged to oppose the stator coil 28c so as to generate an induced current by a rotating magnetic field generated by the stator coil 28c. In order to rotate smoothly around the stator 28, the rotor 30 is supported by a bearing 34 that is attached to a tip of the stator shaft 28b.

The stator base 28a is supported by the upper arm 8a and the lower arm 8b (FIG. 4) that suspend the front wheel of the vehicle 1. Meanwhile, the rotor body 30a is directly fixed to the wheel rim (not illustrated) of the front wheel 2b. The alternating current that is converted by the inverter 20a flows through the stator coil 28c, and the rotating magnetic field is thereby generated. Due to this rotating magnetic field, the induced current is applied to the rotor coil 30b, and the drive power for rotating the rotor body 30a is generated. The drive power that is generated by each of the in-wheel motors 20, just as described, directly and rotationally drives the wheel rim (not illustrated) of each of the front wheels 2b.

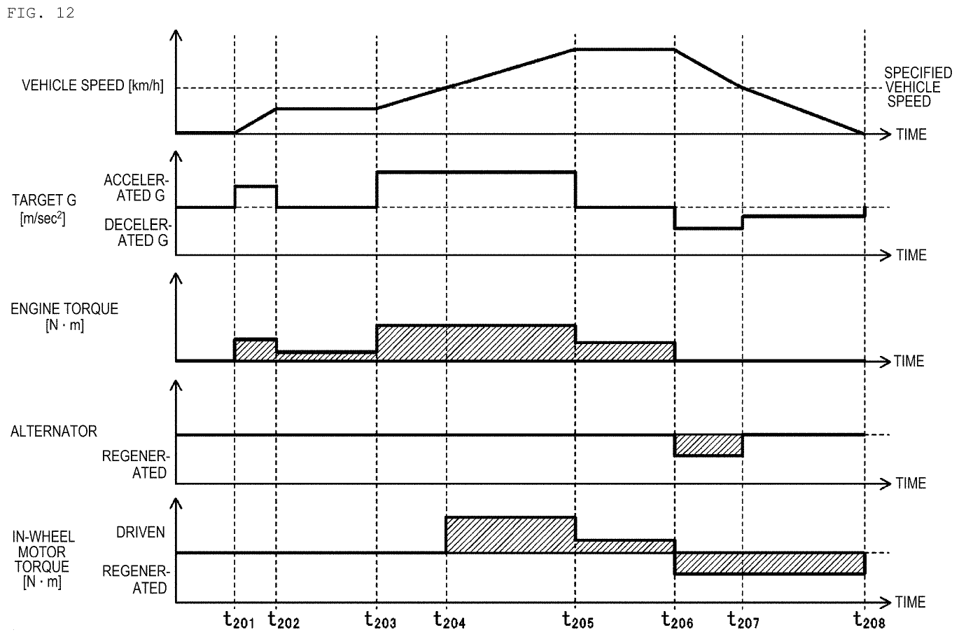

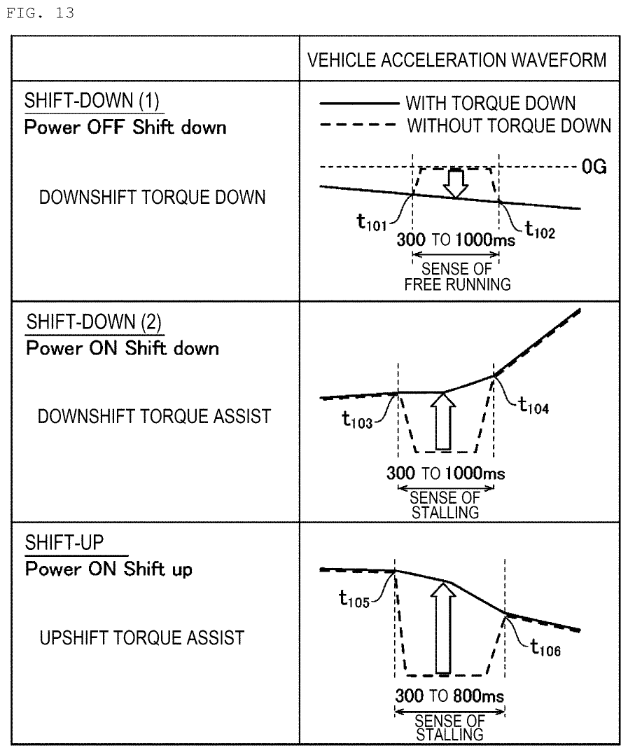

Next, a description will be made on control that is executed by the controller 24 with reference to FIG. 11 and FIG. 12. FIG. 11 is a flowchart of the control by the controller 24, and FIG. 12 is a time chart illustrating an example of the control by the controller 24. After an ignition of the vehicle 1 is turned on, the flowchart illustrated in FIG. 11 is repeatedly executed in specified cycles.

In the time chart illustrated in FIG. 12, the speed of the vehicle 1, target acceleration of the vehicle 1 that is set on the basis of a driving operation by the driver, torque generated by the engine 12, the electricity regenerated by the alternator 16, and torque generated by the in-wheel motor 20 are illustrated in a descending order. In the time chart illustrating the torque of the in-wheel motor 20, a positive value indicates a state where the motor generates the torque, and a negative value indicates a state where the motor regenerates the kinetic energy of the vehicle 1. Here, the controller 24 causes the alternator 16 to generate the electricity when necessary even in the state where the engine 12 generates the torque. However, in an example illustrated in FIG. 12, the electricity is not generated in this state.

First, in step S201 of FIG. 11, the detection signals from the various sensors are read. More specifically, the controller 24 reads the detection signals from the vehicle speed sensor 42, the accelerator operation amount sensor 44, the brake sensor 46, and the like.

Next, in step S202, the target acceleration is set on the basis of the detection signal of each of the sensors that is read in step S201. The target acceleration is set primarily on the basis of a depression amount of an accelerator pedal (not illustrated) that is detected by the accelerator operation amount sensor 44 (FIG. 5). Meanwhile, in the case where the driver intends to decelerate the vehicle 1 and thus depresses a brake pedal (not illustrated), the target acceleration is set to a negative value, and target deceleration is set. The target deceleration (the negative target acceleration) is set primarily on the basis of a depression amount of the brake pedal that is detected by the brake sensor 46 (FIG. 5).

Next, in step S203, it is determined whether the speed of the vehicle 1, which is detected by the vehicle speed sensor 42, is equal to or higher than a specified vehicle speed. If the speed of the vehicle 1 is equal to or higher than the specified vehicle speed, the processing proceeds to step S204. If the speed of the vehicle 1 is lower than the specified vehicle speed, the processing proceeds to step S210. At time t₂₀₁ in FIG. 12, the driver starts the vehicle 1. However, since the vehicle speed is low, the processing in the flowchart proceeds to step S210. In this embodiment, the specified vehicle speed is set to approximately 100 km/h. However, according to characteristics of the adopted engine 12 and the adopted in-wheel motors 20, the specified vehicle speed can be set to the lower vehicle speed than that in this embodiment, for example, approximately 50 km/h.

Furthermore, in step S210, it is determined whether the target acceleration of the vehicle 1 has the negative value (whether or not the target deceleration). If the target acceleration is lower than zero, the processing proceeds to step S211. If the target acceleration is positive or zero, the processing proceeds to step S212. At the time t₂₀₁ in FIG. 12, the driver starts and accelerates the vehicle 1 (the positive target acceleration is set). Thus, the processing in the flowchart proceeds to step S212. In step S212, it is determined whether the target acceleration has the positive value (whether or not the target acceleration). If the target acceleration is positive, the processing proceeds to step S213. If the target acceleration is zero, the processing proceeds to step S214.

At the time t₂₀₁, the positive target acceleration is set. Thus, the processing proceeds to step S213. In step S213, a control parameter for the engine 12 is set to generate the target acceleration by using the drive power of the engine 12. Meanwhile, in step S213, a control parameter for the in-wheel motor 20 is set to a stop (the drive power is not generated, and the kinetic energy is not regenerated). Next, the processing proceeds to step S206. The control parameters set in step S213 are sent from the controller 24 to the engine 12 and the in-wheel motors 20, and the single processing in the flowchart of FIG. 11 is terminated. More specifically, the controller 24 sets the control parameters for the fuel injection valve 58, the ignition plug 60, the intake valve 64, and the like of the engine 12 so as to generate the target acceleration. When the control parameters are sent in step S206, the engine 12 generates the torque, increases the vehicle speed, and thereby generates the target acceleration (the time t₂₀₁ to t₂₀₂ in FIG. 12).

In the example illustrated in FIG. 12, the vehicle 1 is accelerated from the time t₂₀₁ to t₂₀₂. In this period, in the flowchart of FIG. 11, the processing in step S201→S202→S203→S210→S212→S213→S206 is repeatedly executed.

Next, at the time t₂₀₂ in FIG. 12, the driver releases the accelerator pedal. Then, the target acceleration, which is set in step S202 of FIG. 11, is set to zero (constant speed travel). As a result, the processing in the flowchart of FIG. 11 proceeds from step S212→S214. In step S214, the control parameter for the engine 12 is set such that the constant speed travel is maintained by using the drive power of the engine 12. That is, the control parameter is set such that the engine 12 generates the drive power corresponding to travel resistance of the vehicle 1 and thus the constant speed is maintained. For this reason, the drive power that is generated by the engine 12 is reduced from that during the acceleration of the vehicle 1. Meanwhile, in step S214, the control parameter for the in-wheel motors 20 is set to the stop. Next, the processing proceeds to step S206. The control parameters set in step S214 are sent to the engine 12 and the in-wheel motors 20, and the single processing in the flowchart of FIG. 11 is terminated.

In the example illustrated in FIG. 12, the vehicle 1 makes the constant speed travel from the time t₂₀₂ to t₂₀₃. In this period, in the flowchart of FIG. 11, the processing in step S201→S202→S203→S210→S212→S214→S206 is repeatedly executed.

Next, at the time t₂₀₃ in FIG. 12, the driver depresses the accelerator pedal again, and the target acceleration, which is set in step S202 of FIG. 11, is set to the positive value. As a result, the processing in the flowchart of FIG. 11 proceeds from step S212→S213. As described above, in step S213, in order to generate the set target acceleration, the control parameter for the engine 12 is set, and the control parameter for the in-wheel motors 20 is set to the stop. Next, the processing proceeds to step S206. The control parameters set in step S213 are sent to each of the motors, and the single processing in the flowchart of FIG. 11 is terminated.

In the example illustrated in FIG. 12, the vehicle 1 travels at the constant acceleration and the speed thereof is increased from the time t₂₀₃ to t₂₀₄. In this period, in the flowchart of FIG. 11, the processing in step S201→S202→S203→S210→S212→S213→S206 is repeatedly executed.

Next, when the speed of the vehicle 1 reaches the specified vehicle speed (100 [km/h] in this embodiment) at the time t₂₀₄, the processing in the flowchart of FIG. 11 proceeds from step S203→S204.

In step S204, it is determined whether the target acceleration of the vehicle 1 has the negative value (whether or not the target deceleration). If the target acceleration is lower than zero, the processing proceeds to step S205. If the target acceleration is positive or zero, the processing proceeds to step S207. At the time t₂₀₄ in FIG. 12, the driver accelerates the vehicle 1 (the positive target acceleration is set). Thus, the processing in the flowchart proceeds to step S207. In step S207, it is determined whether the target acceleration has the positive value (whether or not the target acceleration). If the target acceleration is positive, the processing proceeds to step S208. If the target acceleration is zero, the processing proceeds to step S209.

At the time t₂₀₄, the positive target acceleration is set. Thus, the processing proceeds to step S208. In step S208, the control parameters for the engine 12 and the in-wheel motors 20 are set to generate the target acceleration by using the drive power of the engine 12 and the in-wheel motors 20. When the vehicle 1 is accelerated in the state where the speed of the vehicle 1 is equal to or higher than the specified vehicle speed, just as described, in addition to the engine 12, the in-wheel motors 20 also generate the drive power. That is, the target acceleration, which is set in step S202, is generated by using the drive power generated by the engine 12 and the in-wheel motors 20. Just as described, the in-wheel motors 20 are used to supplement the drive power by the engine 12 when the vehicle 1 is accelerated in the state where the speed of the vehicle 1 is equal to or higher than the specified vehicle speed. As a result, the amount of the output that should be generated by the engine 12 is reduced. Thus, even in a state where the high output and the high speed are required for the travel of the vehicle 1 (the shaded portion in FIG. 9), the engine 12 can be operated at the substantially stoichiometric air-fuel ratio.

Next, the processing proceeds to step S206. The control parameters set in step S208 are sent to the engine 12 and the in-wheel motors 20, and the single processing in the flowchart of FIG. 11 is terminated. Since the control parameters are sent in step S206, a specified amount of the fuel is supplied to the engine 12, and a specified amount of the electricity is supplied to each of the in-wheel motors 20 from the battery 18 and the capacitor 22 that are connected in series. As a result, the engine 12 and the in-wheel motors 20 generate the torque, increase the vehicle speed, and thereby generate the target acceleration (the time t₂₀₄ to t₂₀₅ in FIG. 12). FIG. 12 illustrates that the engine 12 and the in-wheel motors 20 output constant torque for the constant target acceleration. However, these time charts are schematically illustrated. That is, the travel resistance, air resistance, and the like that act on the vehicle 1 vary by a factor such as the vehicle speed. Thus, the torque that is actually required to maintain the constant target acceleration does not have a constant value.

In the example illustrated in FIG. 12, the vehicle 1 travels at the constant acceleration and the speed thereof is increased from the time t₂₀₄ to t₂₀₅. In this period, in the flowchart of FIG. 11, the processing in step S201→S202→S203→S204→S207→S208→S206 is repeatedly executed.

Next, at the time t₂₀₅ in FIG. 12, the driver releases the accelerator pedal. Then, the target acceleration, which is set in step S202 of FIG. 11, is set to zero (the constant speed travel). As a result, the processing in the flowchart of FIG. 11 proceeds from step S207→S209, and the processing in step S201→S202→S203→S204→S207→S209→S206 is repeatedly executed. In step S209, the control parameters for the engine 12 and the in-wheel motors 20 are set such that the constant speed travel is maintained by using the drive power of the engine 12 and the in-wheel motors 20. Next, the processing proceeds to step S206. The control parameters set in step S209 are sent to the engine 12 and the in-wheel motors 20, and the single processing in the flowchart of FIG. 11 is terminated. Here, the present invention can also be configured to maintain the constant speed travel by using the drive power of any one of the engine 12 and the in-wheel motor 20.

Next, at time t₂₀₆ in FIG. 12, the driver operates the brake pedal (not illustrated) of the vehicle 1, and the target acceleration, which is set in step S202 of the flowchart in FIG. 11, is set to the negative value (the target deceleration). As a result, the processing in the flowchart proceeds from step S204→S205, and the processing in step S201→S202→S203→S204→S205→S206 is repeatedly executed. In step S205, the control parameter is set to stop the fuel that is supplied from the fuel injection valve 58, and the drive power generated by the engine 12 is stopped. In addition, in step S205, the control parameters for the in-wheel motors 20 and the alternator 16 are set such that the in-wheel motors 20 and the alternator 16 regenerate the kinetic energy of the vehicle 1.

Furthermore, in step S206, when the set control parameters are sent to the engine 12, the in-wheel motors 20, and the alternator 16, the kinetic energy is regenerated. The electricity that is generated by the in-wheel motors 20 due to the regeneration of the kinetic energy is stored in the capacitor 22, and the electricity generated by the alternator 16 is stored in the battery 18.

In the case where the vehicle speed is reduced due to the operation of the brake pedal (not illustrated) by the driver, and the speed of the vehicle 1 is reduced to be lower than the specified vehicle speed (in this embodiment, 100 [km/h]) at time t₂₀₇ in FIG. 12, the processing in the flowchart proceeds from step S203→S210→S211, and the processing in step S201→S202→S203→S210→S211→S206 is repeatedly executed. In step S211, the control parameters are set such that the engine 12 is stopped (fuel supply stop), that the in-wheel motors 20 regenerate the kinetic energy of the vehicle 1, and that the alternator 16 stops generating the electricity.

Furthermore, in step S206, when the set control parameters are sent to the engine 12, the in-wheel motors 20, and the alternator 16, the kinetic energy is regenerated by the in-wheel motors 20. The electricity that is generated by the in-wheel motors 20 due to the regeneration of the kinetic energy is stored in the capacitor 22. As a result, the vehicle speed is reduced. Then, at time t₂₀₈ in FIG. 12, the vehicle 1 is stopped.

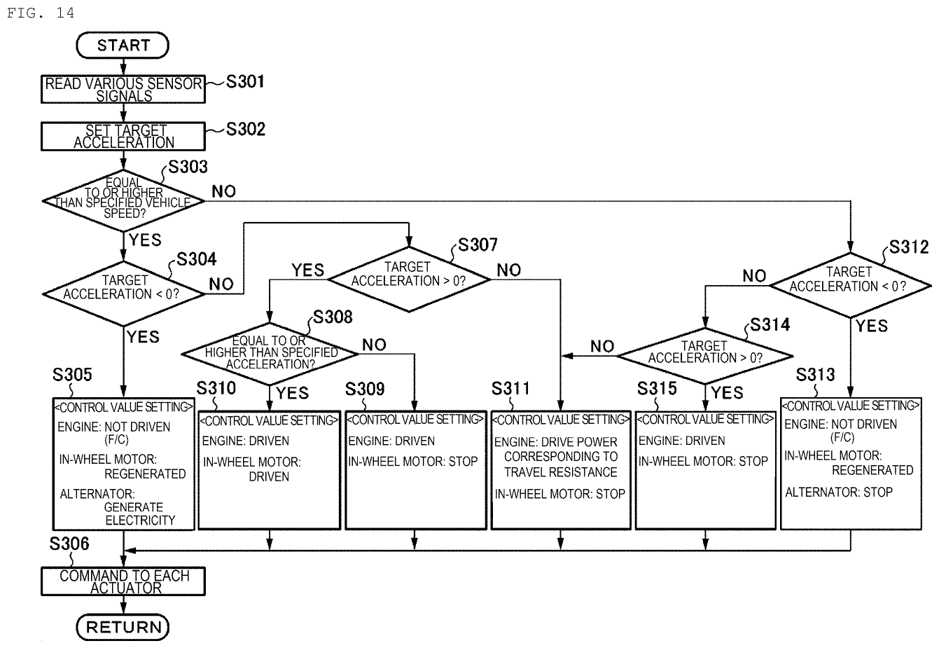

Next, a description will be made on adjustment of the torque at the time of switching the transmission 14c (at the time of gear shifting) with reference to FIG. 13.

FIG. 13 is a table schematically illustrating changes in the acceleration generated in the vehicle in the case where the transmission 14c is shifted up or shifted down. In an order from an upper side, examples of downshift torque down, downshift torque assist, and upshift torque assist are illustrated.

The hybrid drive system 10 according to the first embodiment of the present invention is configured that the controller 24 automatically switches the clutch 14b and the transmission 14c as an automatic transmission according to the vehicle speed or the engine speed when an automatic gearshift mode is set. As illustrated in an upper portion of FIG. 13, when the transmission 14c is shifted down (shifted to a low-speed side) in a state where the negative acceleration is applied to the vehicle 1 during the deceleration (see time t₁₀₁ in FIG. 13), the controller 24 disengages the clutch 14b, and thereby the output shaft of the engine 12 and the primary drive wheels (the rear wheels 2a) are disconnected. When the engine 12 is disconnected from the primary drive wheels, just as described, rotational resistance of the engine 12 is no longer applied to the primary drive wheels. As a result, as indicated by a broken line in the upper portion of FIG. 13, the acceleration that is applied to the vehicle 1 is instantaneously shifted to the positive side. Next, the controller 24 sends the control signal to the transmission 14c, switches the mounted hydraulic solenoid valve 62 (FIG. 5), and thereby increases a reduction ratio of the transmission 14c. Furthermore, at time t₁₀₂ at which shift-down is completed, the controller 24 engages the clutch 14b, and the acceleration is shifted to the negative side again. In general, duration from initiation of shift-down to the completion thereof (the time tin to t₁₀₂) is 300 to 1000 msec, and a so-called torque shock, which is caused by an instantaneous change in the torque applied to the vehicle, gives a sense of free running to the occupant, which may in turn give a sense of discomfort.

In the hybrid drive system 10 of this embodiment, the controller 24 adjusts the toque by sending the control signal to the in-wheel motors 20 during shift-down and thereby suppresses the sense of free running of the vehicle 1. More specifically, when the controller 24 performs shift-down by sending the signal to the clutch 14b and the transmission 14c, the controller 24 reads rotational speeds of an input shaft and the output shaft of the transmission 14c that are respectively detected by the automatic transmission input rotation sensor 50 and the automatic transmission output rotation sensor 52 (FIG. 5). Furthermore, the controller 24 predicts a change in the acceleration generated in the vehicle 1 on the basis of the read rotational speeds of the input shaft and the output shaft, and causes the in-wheel motors 20 to regenerate the energy. In this way, as indicated by a solid line in the upper portion of FIG. 13, the instantaneous increase (change to the positive side) in the acceleration of the vehicle 1, which is caused by the torque shock, is suppressed. Thus, the sense of free running can be suppressed. In addition, in this embodiment, the in-wheel motors 20 complement the torque shock to the primary drive wheels (the rear wheels 2a), which is associated with shift-down, by the secondary drive wheels (the front wheels 2b). Thus, the torque can be adjusted without being influenced by a dynamic characteristic of the power transmission mechanism 14 that transmits the power from the engine 12 to the primary drive wheels.

As indicated by a broken line in an intermediate portion of FIG. 13, in the case where shift-down is initiated at time t₁₀₃ in a state where the positive acceleration is applied to the vehicle 1 during the acceleration, the output shaft of the engine 12 and the primary drive wheels (the rear wheels 2a) are disconnected. As a result, drive torque by the engine 12 is no longer applied to the rear wheels 2a, and the torque shock occurs. Thus, the occupant possibly receives a sense of stalling until shift-down is completed at time t₁₀₄. That is, at the time t₁₀₃ at which shift-down is initiated, the acceleration of the vehicle 1 is instantaneously shifted to the negative side. Then, at the time t₁₀₄ at which shift-down is completed, the acceleration is shifted to the positive side.

In the hybrid drive system 10 of this embodiment, when performing shift-down, the controller 24 predicts the change in the acceleration generated in the vehicle 1 on the basis of the detection signals of the automatic transmission input rotation sensor 50 and the automatic transmission output rotation sensor 52, and causes the in-wheel motors 20 to generate the drive power. In this way, as indicated by a solid line in the intermediate portion of FIG. 13, the instantaneous reduction (change to the negative side) in the acceleration of the vehicle 1, which is caused by the torque shock, is suppressed, and the sense of stalling is thereby suppressed.

Furthermore, as indicated by a broken line in a lower portion of FIG. 13, in the case where shift-up is initiated at time t₁₀₅ in the state where the positive acceleration is applied to the vehicle 1 during the acceleration (the positive acceleration is reduced with time), the output shaft of the engine 12 and the primary drive wheels (the rear wheels 2a) are disconnected. As a result, the drive torque by the engine 12 is no longer applied to the rear wheels 2a, and the torque shock occurs. Thus, the occupant possibly receives the sense of stalling until shift-up is completed at time t₁₀₆. That is, at the time t₁₀₅ at which shift-up is initiated, the acceleration of the vehicle 1 is instantaneously shifted to the negative side. Then, at the time t₁₀₆ at which shift-up is completed, the acceleration is shifted to the positive side.

In this embodiment, when performing shift-up, the controller 24 predicts the change in the acceleration generated in the vehicle 1 on the basis of the detection signals of the automatic transmission input rotation sensor 50 and the automatic transmission output rotation sensor 52, and causes the in-wheel motors 20 to generate the drive power. In this way, as indicated by a solid line in the lower portion of FIG. 13, the instantaneous reduction (change to the negative side) in the acceleration of the vehicle 1, which is caused by the torque shock, is suppressed, and the sense of stalling is thereby suppressed.

As described above, the drive torque that is generated by the in-wheel motors 20 during shift-down or shift-up of the transmission 14c is adjusted in an extremely short time, and does not substantially drive the vehicle 1. Thus, the power that is generated by the in-wheel motors 20 is regenerated by the in-wheel motors 20 and can be generated by using the electric charges that are accumulated in the capacitor 22. In addition, the adjustment of the drive torque generated by the in-wheel motors 20 can be applied to the automatic transmission with a torque converter, the automatic transmission without the torque converter, an automated manual transmission, and the like.

According to the hybrid drive system 10 of the first embodiment in the present invention, in the case where the travel speed of the vehicle 1 is lower than the specified vehicle speed, which is higher than zero, (the time t₂₀₂ to time t₂₀₄ in FIG. 12), the in-wheel motors 20 do not generate the drive power (steps S213, S214 in FIG. 11). Thus, the in-wheel motors 20 are not requested to generate the large torque in the low-speed range. As a result, a small-sized electric motor that generates the small torque in the low-speed range can be adopted as the in-wheel motor 20. Thus, the vehicle can efficiently be driven by using the in-wheel motors 20.

According to the hybrid drive system 10 of this embodiment, in the case where the travel speed of the vehicle 1 is equal to or higher than the specified vehicle speed, the controller 24 causes the in-wheel motors 20 to generate the drive power (the time t₂₀₄ to t₂₀₆ in FIG. 12). In this way, in the high-output/high-speed range (the shaded portion in FIG. 9) where the enrichment control is required in the internal combustion engine, the drive power is supplemented by the in-wheel motors 20. Thus, the enrichment control can be avoided, or the execution of the enrichment control can be suppressed.

According to the hybrid drive system 10 of this embodiment, the wheels are directly driven without the deceleration mechanism being interposed (FIG. 10). Thus, the deceleration mechanism, weight of which is extremely large, can be omitted, and loss of the output by the rotational resistance of the deceleration mechanism can be avoided.

According to the hybrid drive system 10 of this embodiment, the induction motor is adopted as the in-wheel motor 20 that is not requested for the large torque in the low-speed range. Thus, the electric motor capable of generating the sufficient amount of the torque in the required speed range can be configured to have light weight.

According to the hybrid drive system 10 of this embodiment, the engine 12 generates the drive power to start the vehicle 1 (the time t₂₀₁ in FIG. 12). Thereafter, when the travel speed reaches the specified vehicle speed (the time t₂₀₄ in FIG. 12), the in-wheel motors 20 generate the drive power. Thus, the in-wheel motors 20 are not used at the start of the vehicle 1. As a result, the electric motor, starting torque of which is extremely small, can be adopted as each of the in-wheel motors 20, and the in-wheel motors 20 can have light weight.

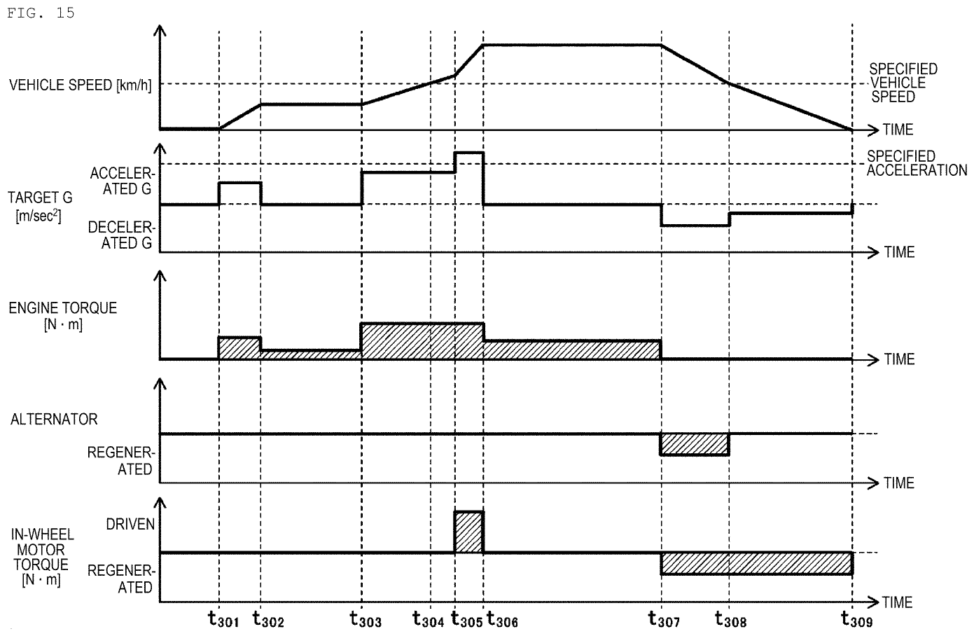

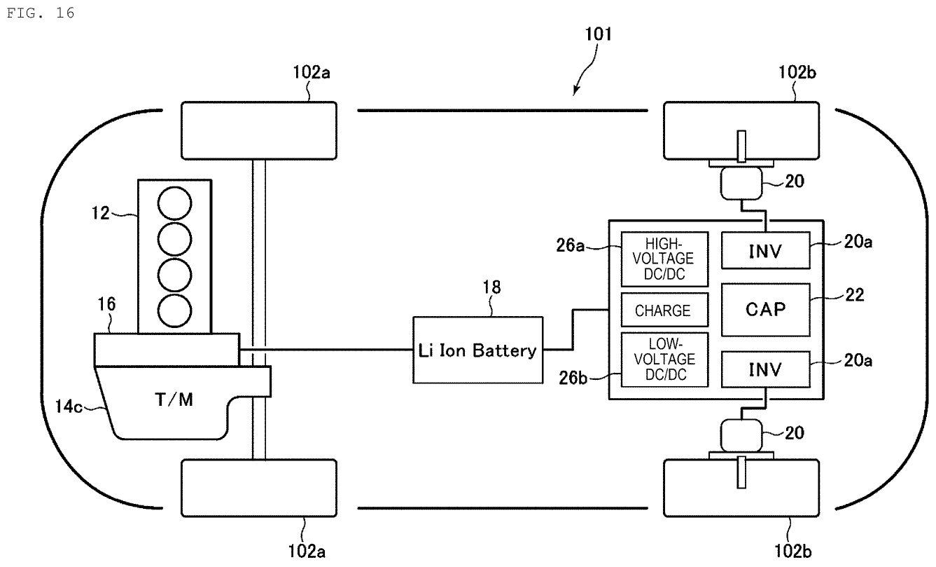

Next, a description will be made on a vehicle drive system that is a hybrid drive system according to a second embodiment of the present invention with reference to FIG. 14 and FIG. 15.

The vehicle drive system according to this embodiment differs from that in the above-described first embodiment in terms of control that is executed by the controller 24. Accordingly, the configuration of the vehicle drive system, which has been described with reference to FIG. 1 to FIG. 10, is the same as that in the first embodiment, and thus the description thereon will not be made. A description will herein be made only on different points in the second embodiment of the present invention from the first embodiment.

FIG. 14 is a flowchart of the control by the controller that is provided in the vehicle drive system according to the second embodiment of the present invention, and FIG. 15 is a time chart illustrating an example of operation of the vehicle drive system. During actuation of the vehicle 1, the flowchart illustrated in FIG. 14 is repeatedly executed in specified cycles.

In the time chart illustrated in FIG. 15, the speed of the vehicle 1, the target acceleration of the vehicle 1 that is set on the basis of the driving operation by the driver, the torque generated by the engine 12, the electricity regenerated by the alternator 16, and the torque generated by the in-wheel motor 20 are illustrated in a descending order. In the time chart illustrating the torque of the in-wheel motor 20, the positive value indicates the state where the motor generates the torque, and the negative value indicates the state where the motor regenerates the kinetic energy of the vehicle 1. Here, the controller 24 causes the alternator 16 to generate the electricity when necessary even in the state where the engine 12 generates the torque. However, in the example illustrated in FIG. 15, the electricity is not generated.

First, in step S301 of FIG. 15, the detection signals from the various sensors are read. More specifically, the controller 24 reads the detection signals from the vehicle speed sensor 42, the accelerator operation amount sensor 44, the brake sensor 46, and the like.

Next, in step S302, the target acceleration is set on the basis of the detection signal of each of the sensors that is read in step S301. The target acceleration is set primarily on the basis of the depression amount of the accelerator pedal (not illustrated) that is detected by the accelerator operation amount sensor 44 (FIG. 5). Meanwhile, in the case where the driver intends to decelerate the vehicle 1 and thus depresses the brake pedal (not illustrated), the target acceleration is set to the negative value, and the target deceleration is set. The target deceleration (the negative target acceleration) is set primarily on the basis of the depression amount of the brake pedal that is detected by the brake sensor 46 (FIG. 5).

Next, in step S303, it is determined whether the speed of the vehicle 1, which is detected by the vehicle speed sensor 42, is equal to or higher than the specified vehicle speed. If the speed of the vehicle 1 is equal to or higher than the specified vehicle speed, the processing proceeds to step S304. If the speed of the vehicle 1 is lower than the specified vehicle speed, the processing proceeds to step S312. At time t₃₀₁ in FIG. 15, the driver starts the vehicle 1. However, since the vehicle speed is low, the processing in the flowchart proceeds to step S312. Also, in this embodiment, the specified vehicle speed is set to approximately 100 km/h.

Furthermore, in step S312, it is determined whether the target acceleration of the vehicle 1 has the negative value (whether or not the target deceleration). If the target acceleration is lower than zero, the processing proceeds to step S313. If the target acceleration is positive or zero, the processing proceeds to step S314. At the time t₃₀₁ in FIG. 15, the driver starts and accelerates the vehicle 1 (the positive target acceleration is set). Thus, the processing in the flowchart proceeds to step S314. In step S314, it is determined whether the target acceleration has the positive value (whether or not the target acceleration). If the target acceleration is positive, the processing proceeds to step S315. If the target acceleration is zero, the processing proceeds to step S311.

At the time t₃₀₁, the positive target acceleration is set. Thus, the processing proceeds to step S315. In step S315, the control parameter for the engine 12 is set to generate the target acceleration by using the drive power of the engine 12. Meanwhile, in step S315, the control parameter for the in-wheel motor 20 is set to the stop (the drive power is not generated, and the kinetic energy is not regenerated). Next, the processing proceeds to step S306. The control parameters set in step S315 are sent from the controller 24 to the engine 12 and the in-wheel motors 20, and the single processing in the flowchart of FIG. 13 is terminated. More specifically, the controller 24 sets the control parameters for the fuel injection valve 58, the ignition plug 60, the intake valve 64, and the like of the engine 12 so as to generate the target acceleration. When the control parameters are sent in step S306, the engine 12 generates the torque, increases the vehicle speed, and thereby generates the target acceleration (the time t₃₀₁ to t₃₀₂ in FIG. 15).

In the example illustrated in FIG. 15, the vehicle 1 is accelerated from the time t₃₀₁ to t₃₀₂. In this period, in the flowchart of FIG. 14, the processing in step S301→S302→S303→S312→S314→S315→S306 is repeatedly executed.

Next, at the time t₃₀₂ in FIG. 15, the driver releases the accelerator pedal. Then, the target acceleration, which is set in step S302 of FIG. 14, is set to zero (the constant speed travel). As a result, the processing in the flowchart of FIG. 14 proceeds from step S314→S311. In step S311, the control parameter for the engine 12 is set such that the constant speed travel is maintained by using the drive power of the engine 12. That is, the control parameter is set such that the engine 12 generates the drive power corresponding to the travel resistance of the vehicle 1 and thus the constant speed is maintained. For this reason, the drive power that is generated by the engine 12 is reduced from that during the acceleration of the vehicle 1. Meanwhile, in step S311, the control parameter for the in-wheel motors 20 is set to the stop. Next, the processing proceeds to step S306. The control parameters set in step S311 are sent to the engine 12 and the in-wheel motors 20, and the single processing in the flowchart of FIG. 14 is terminated.

In the example illustrated in FIG. 15, the vehicle 1 makes the constant speed travel from the time t₃₀₂ to t₃₀₃. In this period, in the flowchart of FIG. 14, the processing in step S301→S302→S303→S312→S314→S311→S306 is repeatedly executed.

Next, at the time t₃₀₃ in FIG. 15, the driver depresses the accelerator pedal again, and the target acceleration, which is set in step S302 of FIG. 14, is set to the positive value. As a result, the processing in the flowchart of FIG. 14 proceeds from step S314→S315. As described above, in step S315, in order to generate the set target acceleration, the control parameters for the engine 12 are set, and the control parameter for the in-wheel motors 20 is set to the stop. Next, the processing proceeds to step S306. The control parameters set in step S315 are sent to each of the motors, and the single processing in the flowchart of FIG. 14 is terminated.

In the example illustrated in FIG. 15, the vehicle 1 travels at the constant acceleration and the speed thereof is increased from the time t₃₀₃ to t₃₀₄. In this period, in the flowchart of FIG. 14, the processing in step S301→S302→S303→S312→S314→S315→S306 is repeatedly executed.

Next, when the speed of the vehicle 1 reaches the specified vehicle speed (100 [km/h] in this embodiment) at the time t₃₀₄, the processing in the flowchart of FIG. 14 proceeds from step S303→S304.

In step S304, it is determined whether the target acceleration of the vehicle 1 has the negative value (whether or not the target deceleration). If the target acceleration is lower than zero, the processing proceeds to step S305. If the target acceleration is positive or zero, the processing proceeds to step S307. At the time t₃₀₄ in FIG. 15, the driver accelerates the vehicle 1 (the positive target acceleration is set). Thus, the processing in the flowchart proceeds to step S307. In step S307, it is determined whether the target acceleration has the positive value (whether or not the target acceleration). If the target acceleration is positive, the processing proceeds to step S308. If the target acceleration is zero, the processing proceeds to step S311.

At the time t₃₀₄, the positive target acceleration is set. Thus, the processing proceeds to step S308. In step S308, it is determined whether the target acceleration is equal to or higher than specified acceleration. In the example illustrated in FIG. 15, the acceleration at the time t₃₀₄ is lower than the specified acceleration. Thus, the processing proceeds to step S309. In this embodiment, the specified acceleration is set to approximately 1.5 m/sec². However, according to the characteristics of the adopted engine 12 and the adopted in-wheel motors 20, the specified acceleration can be set to ta different value. For example, the specified acceleration can be set within a range from approximately 1.5 to 2.5 m/sec². In step S309, in order to generate the set target acceleration, the control parameters for the engine 12 are set, and the control parameter for the in-wheel motors 20 is set to the stop.

Next, the processing proceeds to step S306. The control parameters set in step S309 are sent to the engine 12 and the in-wheel motors 20, and the single processing in the flowchart of FIG. 14 is terminated. When the control parameters are sent in step S306, the engine 12 generates the torque and thereby generates the target acceleration (the time t₃₀₄ to t₃₀₅ in FIG. 15). In the example illustrated in FIG. 15, the vehicle 1 travels at the constant acceleration and the speed thereof is increased from the time t₃₀₄ to t₃₀₅. In this period, in the flowchart of FIG. 14, the processing in step S301→S302→S303→S304→S307→S308→S309→S306 is repeatedly executed.

Next, when the driver further depresses the accelerator pedal at the time t₃₀₅, and the target acceleration, which is set in step S302, consequently becomes equal to or higher than the specified acceleration, the processing in the flowchart of FIG. 14 proceeds from step S308→S310. In step S310, the control parameters for the engine 12 and the in-wheel motors 20 are set such that the target acceleration is generated by using the drive power of the engine 12 and the in-wheel motors 20. As described above, in this embodiment, when the vehicle 1 is accelerated at the specified acceleration or higher in the state where the speed thereof is equal to or higher than the specified vehicle speed, in addition to the engine 12, the in-wheel motors 20 generate the drive power. That is, the target acceleration, which is set in step S302, is generated by using the drive power generated by the engine 12 and the in-wheel motors 20.

Just as described, the in-wheel motors 20 are used to supplement the drive power by the engine 12 when the vehicle 1 is accelerated at the specified acceleration or higher in the state where the speed of the vehicle 1 is equal to or higher than the specified vehicle speed. As a result, the amount of the output that should be generated by the engine is reduced. Thus, even in the state where the high output and the high speed are required for the travel of the vehicle 1 (the shaded portion in FIG. 9), the engine 12 can be operated at the substantially stoichiometric air-fuel ratio.

Next, the processing proceeds to step S306. The control parameters set in step S310 are sent to the engine 12 and the in-wheel motors 20, and the single processing in the flowchart of FIG. 14 is terminated. When the control parameters are sent in step S306, the engine 12 and the in-wheel motors 20 generate the torque, increase the vehicle speed, and thereby generate the target acceleration (the time t₃₀₅ to t₃₀₆ in FIG. 15). In the example illustrated in FIG. 15, the vehicle 1 travels at the constant acceleration and the speed thereof is increased from the time t₃₀₅ to t₃₀₆. In this period, in the flowchart of FIG. 14, the processing in step S301→S302→S303→S304→S307→S308→S310→S306 is repeatedly executed.

Next, at the time t₃₀₆ in FIG. 15, the driver releases the accelerator pedal. Then, the target acceleration, which is set in step S302 of FIG. 14, is set to zero (the constant speed travel). As a result, the processing in the flowchart of FIG. 14 proceeds from step S307→S311, and the processing in step S301→S302→S303→S304→S307→S311→S306 is repeatedly executed. In step S311, the control parameters for the engine 12 and the in-wheel motors 20 are set such that the constant speed travel is maintained by using the drive power of the engine 12 (the in-wheel motors 20 are stopped). Next, the processing proceeds to step S306. The control parameters set in step S311 are sent to the engine 12 and the in-wheel motors 20, and the single processing in the flowchart of FIG. 14 is terminated. Here, the present invention can also be configured to maintain the constant speed travel only by using the drive power of the in-wheel motor 20.

Next, at time t₃₀₇ in FIG. 15, the driver operates the brake pedal (not illustrated) of the vehicle 1, and the target acceleration, which is set in step S302 of the flowchart in FIG. 14, is set to the negative value (the target deceleration). As a result, the processing in the flowchart proceeds from step S304→S305, and the processing in step S301→S302→S303→S304→S305→S306 is repeatedly executed. In step S305, the control parameter is set to stop the fuel that is supplied from the fuel injection valve 58, and the drive power generated by the engine 12 is stopped. In addition, in step S305, the control parameters are set such that the in-wheel motors 20 and the alternator 16 regenerate the kinetic energy of the vehicle 1.

Furthermore, in step S306, when the set control parameters are sent to the engine 12, the in-wheel motors 20, and the alternator 16, the kinetic energy is regenerated. The electricity that is generated by the in-wheel motors 20 due to the regeneration of the kinetic energy is stored in the capacitor 22, and the electricity generated by the alternator 16 is stored in the battery 18.

In the case where the vehicle speed is reduced due to the operation of the brake pedal (not illustrated) by the driver, and the speed of the vehicle 1 is reduced to be lower than the specified vehicle speed (in this embodiment, 100 [km/h]) at time t₃₀₈ in FIG. 15, the processing in the flowchart proceeds from step S303→S312→S313, and the processing in step S301→S302→S303→S312→S313→S306 is repeatedly executed. In step S313, the control parameters are set such that the engine 12 is stopped (the fuel supply stop), that the in-wheel motors 20 regenerate the kinetic energy of the vehicle 1, and that the alternator 16 stops generating the electricity. Furthermore, in step S306, when the set control parameters are sent to the engine 12, the in-wheel motors 20, and the alternator 16, the kinetic energy is regenerated by the in-wheel motors 20. The electricity that is generated by the in-wheel motors 20 due to the regeneration of the kinetic energy is stored in the capacitor 22. As a result, the vehicle speed is reduced. Then, at time t₃₀₉ in FIG. 15, the vehicle 1 is stopped.

The description has been made so far on the vehicle drive systems according to the first and second embodiments of the present invention. In each of the above-described first and second embodiments, the vehicle drive system of the present invention is applied to the FR vehicle. However, the present invention can be applied to various types of vehicles such as a so-called FF vehicle in which the engine is mounted in the front portion of the vehicle and which has the front wheels as the primary drive wheels and a so-called RR vehicle in which the engine is arranged in a rear portion of the vehicle and has the rear wheels as the primary drive wheels.

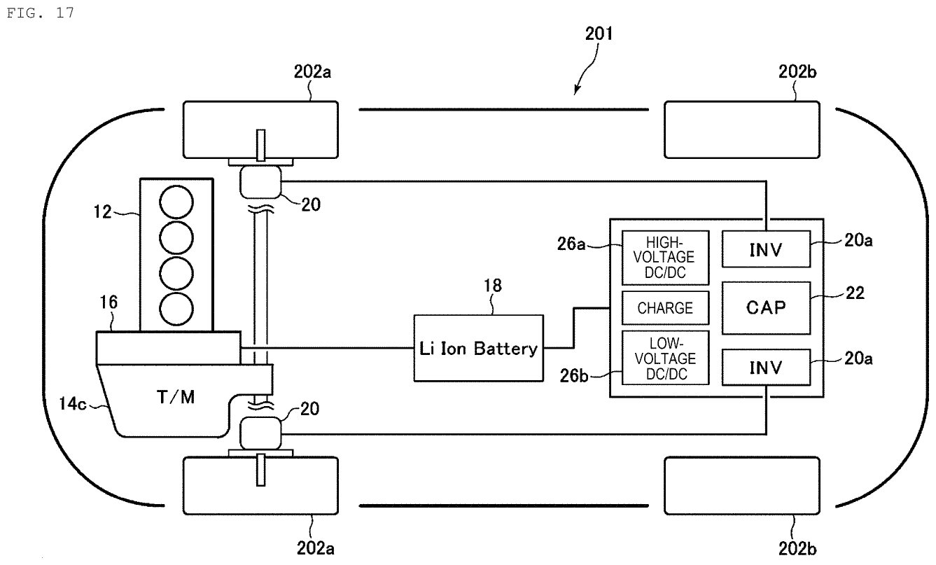

In the case where the present invention is applied to the FF vehicle, for example, as illustrated in FIG. 16, such a layout can be adopted that the engine 12 (and the alternator 16) and the transmission 14c are arranged in a front portion of a vehicle 101 and front wheels 102a are driven as the primary drive wheels. In addition, the in-wheel motor 20 can be arranged to each of right and left rear wheels 102b as the secondary drive wheels. In this way, the present invention can be configured that the engine 12 drives the front wheels 102a as the primary drive wheels and the in-wheel motors 20 drive the rear wheels 102b as the secondary drive wheels. Furthermore, the integral unit in which the capacitor 22, the high-voltage DC/DC converter 26a and the low-voltage DC/DC converter 26b as the voltage converters, and the two inverters 20a are unitized can be arranged in a rear portion of the vehicle 101. Moreover, each of the in-wheel motors 20 can be driven by the electricity that is supplied via respective one of the inverters 20a and that is accumulated in the battery 18 and the capacitor 22 arranged in series.

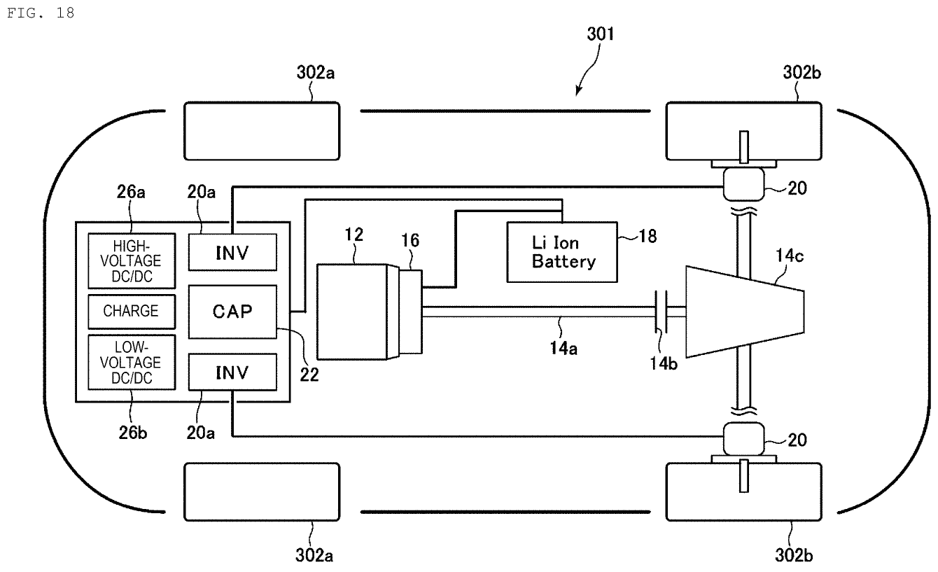

In addition, in the case where the present invention is applied to the FF vehicle, for example, as illustrated in FIG. 17, such a layout can be adopted that the engine 12 (and the alternator 16) and the transmission 14c are arranged in a front portion of a vehicle 201 and front wheels 202a are driven as the primary drive wheels. The in-wheel motor 20 can be arranged to each of right and left front wheels 202a as the primary drive wheels. In this way, the present invention can be configured that the engine 12 drives the front wheels 202a as the primary drive wheels and the in-wheel motors 20 also drive the front wheels 202a as the primary drive wheels. Furthermore, the integral unit in which the capacitor 22, the high-voltage DC/DC converter 26a and the low-voltage DC/DC converter 26b as the voltage converters, and the two inverters 20a are unitized can be arranged in a rear portion of the vehicle 201. Moreover, each of the in-wheel motors 20 can be driven by the electricity that is supplied via respective one of the inverters 20a and that is accumulated in the battery 18 and the capacitor 22 arranged in series.

Meanwhile, in the case where the present invention is applied to the FR vehicle, for example, as illustrated in FIG. 18, such a layout can be adopted that the engine 12 (and the alternator 16) are arranged in a front portion of a vehicle 301, that the power is guided to a rear portion of the vehicle 301 via the propeller shaft 14a, and that rear wheels 302b are driven as the primary drive wheels. The rear wheels 302b are driven by the power, which is guided to the rear portion by the propeller shaft 14a, via the clutch 14b and the transmission 14c as the stepped transmission. In addition, the in-wheel motor 20 can be arranged to each of right and left rear wheels 302b as the primary drive wheels. In this way, the present invention can be configured that the engine 12 drives the rear wheels 302b as the primary drive wheels and the in-wheel motors 20 also drive the rear wheels 302b as the primary drive wheels. Furthermore, the integral unit in which the capacitor 22, the high-voltage DC/DC converter 26a and the low-voltage DC/DC converter 26b as the voltage converters, and the two inverters 20a are unitized can be arranged in a front portion of the vehicle 301. Moreover, each of the in-wheel motors 20 can be driven by the electricity that is supplied via respective one of the inverters 20a and that is accumulated in the battery 18 and the capacitor 22 arranged in series.

The description has been made so far on the preferred embodiments of the present invention. However, various modifications can be made to the above-described embodiments. In particular, in the above-described embodiments, the in-wheel motor is driven by the electricity that is accumulated in the battery and the capacitor connected in series. However, the in-wheel motor may be driven only by the battery.

### REFERENCE SIGNS LIST

1: vehicle
2a: rear wheel (primary drive wheel)
2b: front wheel (secondary drive wheel)
4a: subframe
4b: front side frame
4c: dashboard
4d: propeller shaft tunnel
6a: engine mount
6b: capacitor mount
8a: upper arm
8b: lower arm
8c: spring
8d: shock absorber
10: hybrid drive system (vehicle drive system)
12: engine (internal combustion engine)
14: power transmission mechanism
14a: propeller shaft
14b: clutch
14c: transmission (stepped transmission, automatic transmission)
14d: torque tube
16: alternator
18: battery (power storage device)
20: in-wheel motor
20a: inverter
22: capacitor
22a: bracket
22b: harness
24: controller (control equipment)
25: electrical component
26a: high-voltage DC/DC converter (voltage converter)
26b: low-voltage DC/DC converter
28: stator
28a: stator base
28b: stator shaft
28c: stator coil
30: rotor
30a: rotor body
30b: rotor coil
32: electrical insulating fluid chamber
32a: electrical insulating fluid
34: bearing
42: vehicle speed sensor
44: accelerator operation amount sensor
46: brake sensor
48: engine speed sensor
50: automatic transmission input rotation sensor
52: automatic transmission output rotation sensor
54: voltage sensor
56: current sensor
58: fuel injection valve
60: ignition plug
62: hydraulic solenoid valve
64: intake valve
101: vehicle
102a: front wheel (primary drive wheel)
102b: rear wheel (secondary drive wheel)
201: vehicle
202a: front wheel (primary drive wheel)
301: vehicle
302b: rear wheel (primary drive wheel)

1. A vehicle drive system using an in-wheel motor for driving a vehicle, the vehicle drive system comprising:
a vehicle speed sensor that detects a travel speed of the vehicle;
the in-wheel motor that is provided to a wheel of the vehicle and drives the wheel;
an internal combustion engine that is provided in a vehicle body of the vehicle and drives the wheel; and
control equipment that controls the in-wheel motor and the internal combustion engine,
wherein the control equipment is configured to cause the internal combustion engine to generate drive power and cause the in-wheel motor not to generate the drive power when the travel speed of the vehicle detected by the vehicle speed sensor is lower than a specified vehicle speed that is higher than zero, and
wherein the control equipment is further configured to cause the internal combustion engine and the in-wheel motor to generate the drive power in the case where the travel speed of the vehicle detected by the vehicle speed sensor is equal to or higher than the specified vehicle speed.

2. The vehicle drive system according to claim 1,
wherein the in-wheel motor is configured to directly drive the wheel, to which the in-wheel motor is provided, without a deceleration mechanism being interposed.

3. The vehicle drive system according to claim 1,
wherein the in-wheel motor is an induction motor.

4.-9. (canceled)

10. The vehicle drive system according to claim 2,
wherein the in-wheel motor is an induction motor.

11. The vehicle drive system according to claim 1,
wherein the control equipment is configured to cause the internal combustion engine to generate the drive power and thereby cause the vehicle to start moving and, when the travel speed of the vehicle detected by the vehicle speed sensor reaches the specified vehicle speed, to cause the in-wheel motor to generate the drive power.

12. The vehicle drive system according to claim 2,
wherein the control equipment is configured to cause the internal combustion engine to generate the drive power and thereby cause the vehicle to start moving and, when the travel speed of the vehicle detected by the vehicle speed sensor reaches the specified vehicle speed, to cause the in-wheel motor to generate the drive power.

13. The vehicle drive system according to claim 3,
wherein the control equipment is configured to cause the internal combustion engine to generate the drive power and thereby cause the vehicle to start moving and, when the travel speed of the vehicle detected by the vehicle speed sensor reaches the specified vehicle speed, to cause the in-wheel motor to generate the drive power.

14. The vehicle drive system according to claim 10,
wherein the control equipment is configured to cause the internal combustion engine to generate the drive power and thereby cause the vehicle to start moving and, when the travel speed of the vehicle detected by the vehicle speed sensor reaches the specified vehicle speed, to cause the in-wheel motor to generate the drive power.

15. The vehicle drive system according to claim 1,
wherein the in-wheel motor is configured to drive a front wheel of the vehicle, and the internal combustion engine is configured to drive a rear wheel of the vehicle.

16. The vehicle drive system according to claim 2,
wherein the in-wheel motor is configured to drive a front wheel of the vehicle, and the internal combustion engine is configured to drive a rear wheel of the vehicle.

17. The vehicle drive system according to claim 1,
wherein the in-wheel motor is configured to drive a rear wheel of the vehicle, and the internal combustion engine is configured to drive a front wheel of the vehicle.

18. The vehicle drive system according to claim 2,
wherein the in-wheel motor is configured to drive a rear wheel of the vehicle, and the internal combustion engine is configured to drive a front wheel of the vehicle.

19. The vehicle drive system according to claim 1,
wherein the in-wheel motor and the internal combustion engine are configured to drive a front wheel of the vehicle.

20. The vehicle drive system according to claim 2,
wherein the in-wheel motor and the internal combustion engine are configured to drive a front wheel of the vehicle.

21. The vehicle drive system according to claim 1,
wherein the in-wheel motor and the internal combustion engine are configured to drive a rear wheel of the vehicle.

22. The vehicle drive system according to claim 2,
wherein the in-wheel motor and the internal combustion engine are configured to drive a rear wheel of the vehicle.

23. A vehicle drive system using an in-wheel motor for driving a vehicle, the vehicle drive system comprising:
a vehicle speed sensor that detects a travel speed of the vehicle;
the in-wheel motor that is provided to a wheel of the vehicle and drives the wheel;
an internal combustion engine that is provided in a vehicle body of the vehicle and drives the wheel; and
control equipment that controls the in-wheel motor and the internal combustion engine,
wherein the control equipment is configured to cause the internal combustion engine to generate drive power and thereby cause the vehicle to start moving and, when the travel speed of the vehicle detected by the vehicle speed sensor reaches a specified vehicle speed that is higher than zero, to cause the in-wheel motor to generate the drive power.
